(19) United States
(12) Patent Application Publication
(10) Pub. No.: US 2005/0177597 A1
(43) Pub. Date: Aug. 11, 2005

(54) System and method of exercising a browser

(76) Inventor: Steve Elmer, Cupertino, CA (US)

Correspondence Address: GLENN PATENT GROUP, 3475 EDISON WAY, SUITE L, MENLO PARK, CA, 94025, US

(21) Appl. No.: 10/773,068

(22) Filed: Feb. 4, 2004

(51) Int. Cl. G06F 7/00

(52) U.S. Cl. 707/104.1

(57) ABSTRACT

A method of testing browser software in a computer environment includes the steps of generating a list of URLs (Universal Resource Location) using a web crawler, automatically instructing a first browser program to load and render web pages according to the list of URLs, detecting one or more errors in rendering of the first browser program the web pages; and automatically storing information about the one or more errors.

### FIELD OF THE INVENTION

This invention relates to a method of exercising a browser in a computer environment. More particularly, the invention relates to a method of exercising a browser to discover websites causing crashes in a computer environment.

### BACKGROUND OF THE INVENTION

The address of a web page can be specified using a URL (Universal Resource Locator). A web page may contain one or more addresses of other web pages to provide links to these web pages. When the web page is displayed using a web browser, such as a Netscape browser or an Internet Explorer, a user can easily follow the links to move from one web page to another.

It is a common problem when a browser crashes when a user browses different websites on the Internet. Attempts have been made to collect information regarding these websites that cause a browser to crash in an effort to avoid future reoccurrence of the same problem. For example, the Talkback system implemented by the Netscape browser aims to record the URLs of the crashing websites. However, systems such as the Talkback collect the URL information of the websites visited by the user randomly.

A web crawler is an automated program that automatically follows the links in the web pages to visit web sites. A web crawler typically visits various web sites on behalf of the web search engines or web directories. Crawlers are typically used to process and index the contents of web pages that can be found by the crawlers so that the web pages can be indexed in the database of a search engine or a web directory. For example, Googlebot is the crawler that travels across the web, finding and indexing pages for the Google search engine.

The content of a web page may be defined using many different languages, such as different versions of HyperText Markup Languages (HTML), Java scripts, Java programs, and others. The standards for defining a web page continuously evolve. The web pages available on the Internet in general may use different standards. A robust web browser must be able to handle various web pages available on the web.

FIG. 1 is a block schematic diagram showing a method of testing a web browser according to prior art. Referring now to FIG. 1, when a developer 104 of a web browser has a working version of the browser, the browser software program is distributed to various users for testing. For example, the browser software program can be released as an alpha or beta version for the users to try out. The users may install the browser on their computers, which are in general have different computing environment, such as user computer A 106 and user computer B 108.

For example, the user computers 106, 108 may have different versions of an operating system running on different hardware configurations. When the users try out the browser, they may visit various web sites, such as those hosted on a web server A 110, a web server B 112, a web server X 114, and others, through the Internet 102. The users may see the rendering results of the browser.

When the users notice the glitches in the rendering results of the browser, they may submit reports to the developer 104 so that the developer may fix the glitches in the next release of the browser. When the browser crashes, an automated reporting system, such as the Talkback system from www.support.com, can be used to send the information about the crash from the user computer to the developer. Such a testing methodology allows the developer to discover the errors and glitches in the browser software program on a variety of platforms and web pages.

### SUMMARY OF THE INVENTION

While a web browser typically renders a web page for display as an screen image, the term “browser program” in this application generally refers to a software program which retrieves the data for a web page when given an address of the web page, such as in the URL format, and interpret the data for the web page to generate a representation of the web page.

One embodiment of the invention provides a testing methodology executed by a computer to exercise a browser to discover errors in the browser. For example, web sites may cause crashes in the browser. To automatically record information about the crashes, the browser is enabled with a crash-reporting module. A web crawler and an associated script are then used to drive the browser to visit all sites that the web crawler can reach. For example, the crawler can create a file containing URLs for the browser to visit. The script then causes the browser to visit each of those URLs. The system keeps track of the URLs visited such that it can resume at a URL following the one that caused any crash and avoid duplicating prior visits.

### BRIEF DESCRIPTION OF THE DRAWINGS

FIG. 1 is a block schematic diagram showing a system for testing a web browser according to prior art;

FIG. 2 is a block schematic diagram showing a system for testing a browser according to one embodiment of the invention;

FIG. 3 is a block schematic diagram showing another system of testing a browser according to one embodiment of the invention;

FIG. 4 is a block diagram showing a method of testing a browser program according to one embodiment of the invention; and

FIG. 5 is a block diagram showing a method of testing a browser program according to one embodiment of the invention.

### DETAILED DESCRIPTION OF THE INVENTION

In one embodiment of the invention, in order to discover live websites that cause a browser to crash, a web crawler utility is used to cause a version of the browser with an automated crash reporting system, such as Talkback from support.com, to load web pages found by the crawler.

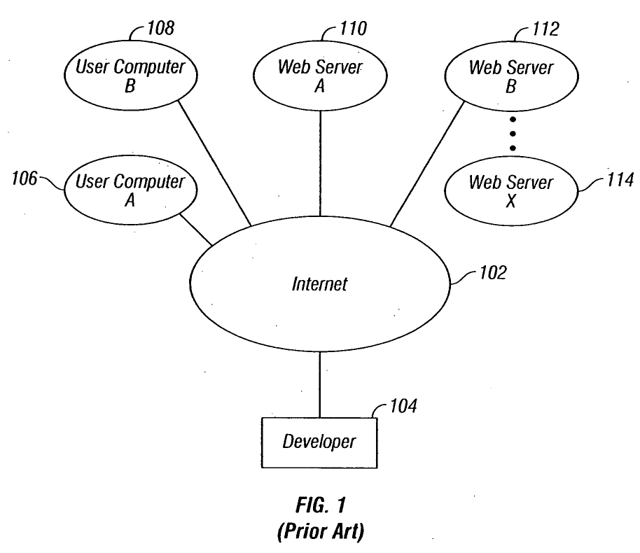

The prior art system for testing a browser, as illustrated in FIG. 1, can help a developer to discover the errors and glitches in the browser software program on a variety of platforms and web pages. However, such testing is limited to the extent of the distribution of the browser software for try out and the extent of the try out usage. Typically, the tested web pages in the prior art method were limited to a random collection of sites visited by actual users. Although the sample may be quite large, there is no way to control websites coverage or timeliness. One advantage of real usage for try-out is that most possible computer configurations are sampled without internal cost to the developer, if the browser software is widely distributed for try-out.

One embodiment of the invention provides a testing methodology executed by a computer to exercise a browser in order to discover web sites that cause crashes and/or glitches in that browser. The browser may be enabled with a crash-reporting module, such as Talkback from supporting.com. For example, a web crawler and an associated script can be used to drive the browser to visit all sites that the web crawler can reach.

One embodiment of the invention methodically visits all known sites on the web within the capabilities of the web crawler, so that the progress of testing can be controlled and monitored to ensure adequate coverage. For example, when a new browser is being developed but no extended user base is available due to the constraints on its distribution, it's impossible to have large numbers of users running the new browser to try it out. Thus, an automated method of visiting websites to detect crashes and glitches can be very valuable to the development of the new browser.

In one implementation, a web crawler is used to create a file containing URLs for the browser to visit. Then, a script or program can be used to cause the browser to visit those URLs one after another. For example, the script may transform the file containing the URLs generated by the web crawler into a format usable by the browser. Further, the system can keep track of each URL visited such that it can resume at the URL following the one that caused any crash and avoid duplicating prior visits.

In one embodiment, ancillary features such as direct control of the URLs can also be implemented. For example, a list of URLs can be skipped, because these URLs are already known to cause crashes or not desirable to visit for some other reasons.

In one embodiment of the invention, an existing browser with known capabilities is used to measure against the new browser. For example, the web crawler and the test controlling module causes both browsers to visit the same URL so that the results can be compared. When the results differ, the new browser may have been in error. Thus, a known browser can be used to validate a new browser. More details are provided below.

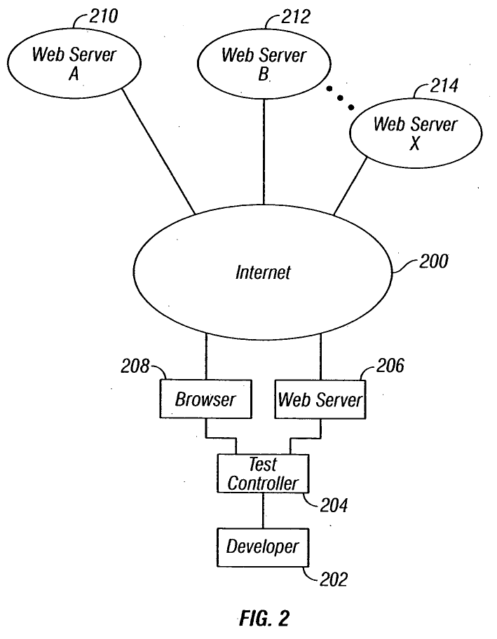

FIG. 2 is a block schematic diagram showing a system for testing a browser according to one embodiment of the invention. A system for testing a browser according to one embodiment of the invention includes the internet 200, a developer 202, a test controller 204, a web crawler 206, a browser 208 and one or more web servers 210-214 connected to the Internet 200.

Referring now to FIG. 2, the developer 202 develops the test controller 204 that causes the browser 208 to visit a list of URLs. The web crawler 206 is used to find the list of URLs through the Internet 200. For example, when given a top domain name, such as www.aol.com, the web crawler 206 retrieves the web page from http://www.aol.com/ and analyses the web page to discover any new links in the web page at http://www.aol.com/. Then, the web crawler visits the new links found on the web page at http://www.aol.com/ to find more new links.

Thus, the web crawler 206 repeatedly finds the new links on the visited web pages and then follows the new links found on the visited web pages to visit more linked web pages.

Any web-crawling methods used for indexing web pages can be used to generate the list of URLs. The test controller 204, which can be a simple script and a separate software program, may be used to cause the browser 208 to methodically visit URLs discovered by the web crawler 206. Alternatively, the test controller 204 can be a module of the web crawler 206.

When a web page at a URL causes the browser to crash, the test controller 204 restarts the browser 208 and records the information about the crashing. This information can be presented to the developer 202 to improve the performance of the browser 208.

In one embodiment, the browser 208 contains a module for an automated crash reporting system. The test controller 204 may be used to collect the reports from the automated crash-reporting module. Thus, when the web crawler 206 is used, the browser 208 can be exercised to the extent of web coverage within the capability of the web crawler 206.

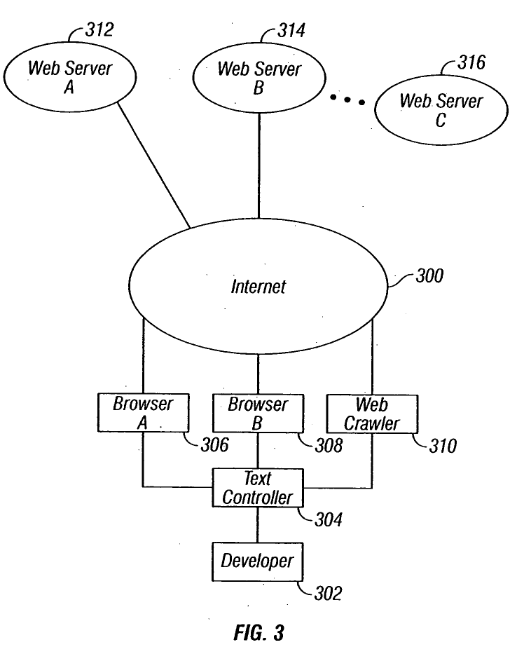

FIG. 3 is a block schematic diagram showing another system for testing a browser according to one embodiment of the invention. The system for testing a browser according to one embodiment of the invention includes the Internet 300, a developer 302, a test controller 304, a browser A 306, a browser B 308, a web crawler 310, and one or more web servers 312, 314, 316 connected to the Internet 300.

Referring now to FIG. 3, the developer 302 develops the test controller 304 that causes the browsers A and B 306, 308 to visit a list of URLs. A web crawler 306 finds a list of URLs of web pages hosted on web servers 312, 314 and 316 connected through the Internet 300.

For example, when given the top domain name aol.com, the web crawler 310 finds all the URLs found within the domain aol.com starting from the web page at the URL http://www.aol.com/. When the web crawler 310 finds a new URL, the test controller 304 causes both browser A 306 and browser B 308 to visit the same new URL. After the browsers 306 and 308 render the same web page at the same new URL, the test controller 304 compares the rendered results of the same web page from the two browsers 306 and 308.

When there is a difference in the rendered results, information about the difference is recorded for further analysis by the developer 302. For example, the browser B 308 may be a well-tested browser, while the browser A 306 is currently under development. Thus, when the rendered results of the two browsers A and B 306 and 308 differ from each other, it is likely that the browser A 306 under development has a glitch in rendering the web page. The test controller 304 may store and/or display the rendered images of the web page from the two browsers A and B 306 and 308 so that the developer 302 can quickly identify if there is any glitch.

The test controller 304 may directly compare the screen images of the web page rendered by the two browsers A and B 306, 308. However, the exact comparison based on screen images of the two browsers A and B 306, 308 may trigger too many false alarms since the different browsers may both correctly render the same web page in different layouts. In addition, the definitions of the web pages, e.g., the html documents, generally do not completely specify the layout of the document. Thus, different browsers can correctly render the same web page into different images.

In one embodiment, both browsers A and B, 306, 308 present an internal representation of the web page from which the screen images are generated to the test controller 304. Thus, the internal representations of the web page can be compared for glitches.

In one embodiment, the internal representation only shows certain aspects of the web page. For example, the internal representation may show a background color, the number of rows and columns in a table, and others. These attributes of the internal representation can be selectively compared for the detection of glitches. Although such comparison may not guarantee to catch all glitches or avoid all false alarms, the results of the automated detection can be still provides useful information for the developer 302 to improve the product.

In one embodiment, the internal representation includes a list of objects to be displayed for the web page and the attributes of the objects. The list of objects and their attributes are derived from the web page. The attributes and the objects that are uniquely defined by the web page are compared to ensure that there is no glitch in interpreting the information defining the web page.

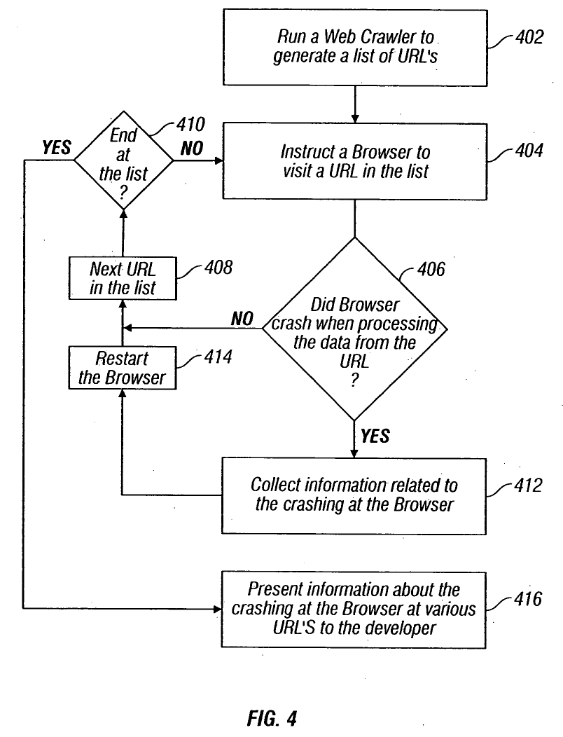

FIG. 4 is a block diagram showing a method of testing a browser program according to one embodiment of the invention. A method of testing a browser program according to one embodiment of the invention includes the steps of running a web crawler to generate a list of URLs 402; instructing a browser to visit the URL 404; determining if the browser crashed when processing the data from the given URL 406; collecting the information related to the crashing of the browser if the browser crashed 412; and presenting information about the crashing of the browser at various URLs to a developer 416; alternatively, visiting a next URL if the browser did not crash in a prior visit 408.

Referring now to FIG. 4, a test controller runs a web crawler to generate a list of URLs 402. The test controller may use all the URLs found by the web crawler or exclude some of the URLs for certain reasons, such as the URLs that are known to cause crashes or known to have ill-formed html documents, or not desirable to visit for some other reasons.

The test controller instructs a browser to visit each URL in the list 404. The browser visits the URL by downloading information for rendering the web page at the URL and processing the downloaded information for the web page.

It is then determined if the browser crashed during a prior visit when processing the data from the given URL 406. If it is determined that the browser crashed during a prior visit 406, the test controller collects the information related to the crashing of the browser 412, such as the core dumped by the crashed browser,

The test controller restarts the browser 414. Alternatively, the test controller may restart the browser before collecting the information related to the crash. For example, the browser may have automated crash-reporting module, which when restarted, automatically reports information about the crash.

After a URL is visited, the test controller processes to the next URL in the list of URL 408.

It is then determined whether the end of the URL list has been reached 410. If it is determined that the end of the list has not been reached 410, the test controller continues to instruct the browser to visit the next URL 404.

If it is determined that the end of the list has been reached 410, the test controller finishes the testing and presents the information about the crashing of the browser at various URLs to a developer 416.

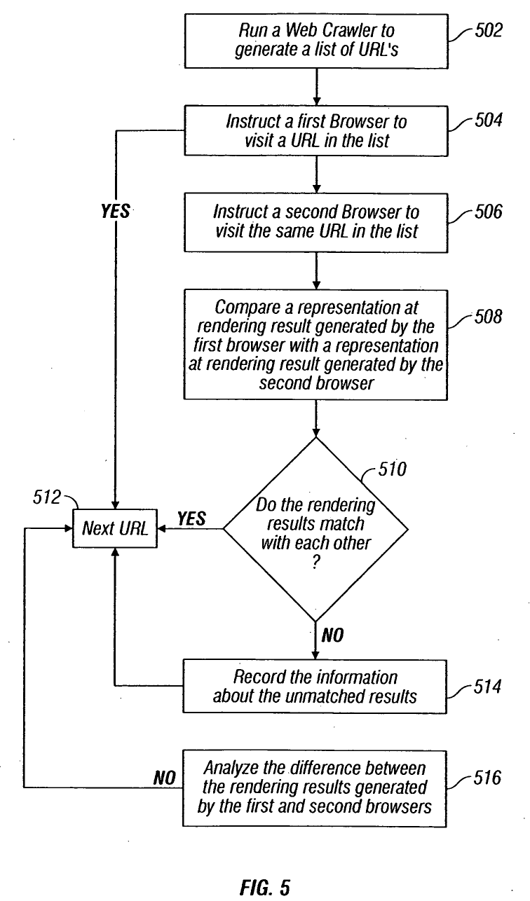

FIG. 5 is a block diagram showing a method of testing a browser program according to one embodiment of the invention. Referring now to FIG. 5, a method of testing a browser program according to one embodiment of the invention provides a method of comparing the presentations of two browsers and analyzing the difference between the results of the comparison of the two browsers.

In FIG. 5, a web crawler runs to generate a list of URLs 502. A first browser is then instructed to visit a URL in the list 504. A second browser is also instructed to visit the same URL in the list 506. The first and second browser each downloads the information defining the web page at the URL and processes the information defining the web page.

A representation of the results generated by the first browser is compared with a representation of rendering result generated by the second browser 508.

It is then determined if the generated results from the first and second browsers match with each other 510. If the results do not match, information about the unmatched results is recorded 514. If the results match, the comparison for the next URL is performed 512 until the end of the list is reached.

After the results about the unmatched results are presented to a developer, the difference between the rendering results generated by the first and second browsers can be analyzed for improvement 516.

It is important to note that embodiments of the invention include an apparatus for updating address information according to the methods described above and a program storage medium readable by a computer, tangibly embodying a program of instructions executable by the computer to perform the method for updating address information as described above.

Although the invention is described herein with reference to the preferred embodiment, one skilled in the art will readily appreciate that other applications may be substituted for those set forth herein departing from the spirit and scope of the present invention. Accordingly, the invention should only be limited by the claims included below.

1. A method of testing browser software in a computer environment, the method comprising the steps of:
generating a list of URLs (Universal Resource Location) using a web crawler;
automatically instructing a first browser program to load and render web pages according to the list of URLs;
detecting one or more errors in rendering of the first browser program the web pages; and
automatically storing information about the one or more errors.

2. The method of claim 1, wherein the one or more errors include a crash of the first browser program in rendering one of the web pages.

3. The method of claim 1, wherein the detecting of the one or more errors comprising the step of:
automatically instructing a second browser program to load and render the web pages; and
comparing a representation of rendering results of the first browser program to a representation of rendering results of the second browser program.

4. The method of claim 3, wherein one or more errors are detected when the representation of rendering results of the first browser program does not match the representation of rendering results of the second browser program.

5. The method of claim 4, wherein the representation of rendering results of the first browser program comprises a screen image of a web page rendered by the first browser program.

6. The method of claim 4, wherein the representation of rendering results of the first browser program comprises an internal representation of a web page as interpreted by the first browser program.

7. The method of claim 6, the internal representation of the web page comprises attributes of the web page, including:
a background color;
a number of columns of a table; and
a number of rows of a table.

8. The method of claim 1, further comprising the step of:
automatically restarting the first browser program after a crash of the first browser program in rendering one of the web pages.

9. The method of claim 1, further comprising the step of avoiding duplicated visits to a same URL.

10. The method of claim 1, wherein a number of URLs are removed from the URLs reported by the web crawler to generate the list of URLs.

11. An apparatus of testing browser software in a computer environment, comprising:
a module for generating a list of URLs (Universal Resource Location) using a web crawler;
a module for automatically instructing a first browser program to load and render web pages according to the list of URLs;
a module for detecting one or more errors in rendering of the first browser program the web pages; and
a module for automatically storing information about the one or more errors.

12. The apparatus of claim 11, wherein the one or more errors include a crash of the first browser program in rendering one of the web pages.

13. The apparatus of claim 11, wherein the module for the detecting of the one or more errors comprising:
a module for automatically instructing a second browser program to load and render the web pages; and
a module for comparing a representation of rendering results of the first browser program to a representation of rendering results of the second browser program.

14. The apparatus of claim 11, wherein one or more errors are detected when the representation of rendering results of the first browser program does not match the representation of rendering results of the second browser program.

15. The apparatus of claim 14, wherein the representation of rendering results of the first browser program comprises a screen image of a web page rendered by the first browser program.

16. The apparatus of claim 14, wherein the representation of rendering results of the first browser program comprises an internal representation of a web page as interpreted by the first browser program.

17. The apparatus of claim 16, the internal representation of the web page comprises attributes of the web page, including:
a background color;
a number of columns of a table; and
a number of rows of a table.

18. The apparatus of claim 11, further comprising:
a module for automatically restarting the first browser program after a crash of the first browser program in rendering one of the web pages.

19. The apparatus of claim 11, further comprising a module for avoiding duplicated visits to a same URL.

20. The apparatus of claim 11, wherein a number of URLs are removed from the URLs reported by the web crawler to generate the list of URLs.

21. A program storage medium readable by a computer, tangibly embodying a program of instructions executable by the computer to perform a method for of testing browser software in a computer environment, the method comprising the steps of:
generating a list of URLs (Universal Resource Location) using a web crawler;
automatically instructing a first browser program to load and render web pages according to the list of URLS;
detecting one or more errors in rendering of the first browser program the web pages; and
automatically storing information about the one or more errors.

22. The medium of claim 21, wherein the one or more errors include a crash of the first browser program in rendering one of the web pages.

23. The medium of claim 21, wherein the method of detecting of the one or more errors comprising the step of:
automatically instructing a second browser program to load and render the web pages; and
comparing a representation of rendering results of the first browser program to a representation of rendering results of the second browser program.

24. The medium of claim 23, wherein one or more errors are detected when the representation of rendering results of the first browser program does not match the representation of rendering results of the second browser program.

25. The medium of claim 24, wherein the representation of rendering results of the first browser program comprises a screen image of a web page rendered by the first browser program.

26. The medium of claim 24, wherein the representation of rendering results of the first browser program comprises an internal representation of a web page as interpreted by the first browser program.

27. The medium of claim 26, the internal representation of the web page comprises attributes of the web page, including:
a background color;
a number of columns of a table; and
a number of rows of a table.

28. The medium of claim 21, the method further comprising the step of:
automatically restarting the first browser program after a crash of the first browser program in rendering one of the web pages.

29. The medium of claim 21, the method further comprising the step of avoiding duplicated visits to a same URL.

30. The medium of claim 21, wherein a number of URLs are removed from the URLs reported by the web crawler to generate the list of URLs.
